(19) United States
(12) Patent Application Publication
(10) Pub. No.: US 2019/0135204 A1
(43) Pub. Date: May 9, 2019

(54) GROMMET AND WIRE HARNESS

(71) Applicant: SUMITOMO WIRING SYSTEMS, LTD., Yokkaichi-shi, Mie (JP)

(72) Inventor: Yuki OOHIRA, Yokkaichi (JP)

(73) Assignee: SUMITOMO WIRING SYSTEMS, LTD., Yokkaichi-shi, Mie (JP)

(21) Appl. No.: 16/307,301

(22) PCT Filed: May 26, 2017
(86) PCT No.: PCT/JP2017/019673

§ 371 Date: Dec. 5, 2018

(30) Foreign Application Priority Data
Jun. 16, 2016 (JP) 2016-119594

(51) Int. Cl. B60R 16/02; H01B 17/58; H01B 7/18; H01B 7/282; H02G 3/22

(52) U.S. Cl. CPC B60R 16/0222; H01B 17/583; H02G 3/22; H01B 7/282; H01B 7/18

(57) ABSTRACT

A grommet that has a tubular shape capable of enveloping a wire harness and is arranged at a middle in a length direction of the wire harness, the grommet including: a main body whose one end in an axial direction is connected to an end of one external member configured to envelope the wire harness and another end is connected to an end of another external member that is different from the one external member; and a housing that is provided in the main body and is capable of housing a magnetic core between the end of the one external member and the end of the other external member.

This application is the U.S. National Phase of PCT/JP2017/019673 filed May 26, 2017, which claims priority from JP 2016-119594 filed Jun. 16, 2016, the entire disclosure or which is incorporated herein by reference.

### BACKGROUND

The present disclosure relates to a grommet and a wire harness.

Conventionally, waterproofing and protecting a wire harness attached to a vehicle by enveloping the wire harness with an external member such as a pipe or a corrugated tube that is made of a synthetic resin or metal is known (disclosed in JP 2013-62063A for example).

Also, attaching a magnetic core to a wire harness to function as a noise absorption tool is known. For example, with a wire harness disclosed in Patent JP 2015-27205A, a magnetic core is housed in a housing case made of a synthetic resin, and is mounted on the outside of a corrugated tube.

### SUMMARY

However, as described above, the configuration in which the magnetic core is mounted on the outside of the external member is problematic in that the site at which the magnetic core is mounted has to have an increased diameter. Having said that, it is difficult to insert the magnetic core into a predetermined site from an end of the external member, and it is not desirable that the external member is split into a half-split structure because this half-split structure will reduce the waterproofness thereof.

An exemplary aspect of the disclosure provides a grommet that allows easy attachment of a magnetic core to a wire harness while suppressing an increase in the diameter of the wire harness, and a wire harness.

capable of enveloping a wire harness and is arranged at a middle in a length direction of the wire harness, the grommet including a main body whose one end in an axial direction is connected to an end of one external member configured to envelope the wire harness and another end is connected to an end of another external member that is different from the one external member, and a housing that is provided in the main body and is capable of housing a magnetic core between the end of the one external member and the end of the other external member.

The wire harness of the present disclosure includes the grommet, a magnetic core housed in the housing of the grommet, and another external member configured to envelope the wire harness.

According to the present disclosure, it is possible to suppress an increase in the diameter of the wire harness, compared to the case where the magnetic core is mounted on the outside of the external member. Also, the grommet has a short length, and thus the magnetic core can be easily inserted from an end thereof. That is, according to the disclosure of this application, it is possible to easily attach a magnetic core to a wire harness while suppressing an increase in the diameter of the wire harness.

### BRIEF DESCRIPTION OF THE DRAWINGS

FIG. 1 is a perspective view showing a wire harness in this embodiment.

FIG. 2 is a perspective view showing a grommet.

FIG. 3 is a side view showing the grommet.

FIG. 4 is a bottom view showing the grommet.

FIG. 5 is a cross-sectional view showing the grommet and corresponds to the cross-section at position A-A in FIG. 3.

FIG. 6 is a cross-sectional view showing the grommet and corresponds to the cross-section at position B-B in FIG. 3.

FIG. 7 is a cross-sectional view showing the grommet and corresponds to the cross-section at position C-C in FIG. 3.

### DETAILED DESCRIPTION OF EMBODIMENTS

A preferred embodiment of the present disclosure will be described below.

The grommet of the present disclosure may have a configuration in which the main body is provided with a through-hole into which a waterproof member with gas permeability can be fitted. Such a configuration makes it possible to provide the grommet for housing the magnetic core that may act as a heat source with an airflow structural portion, and thus to effectively adjust the internal pressure of the external member.

Also, the grommet of the present disclosure may have a configuration in which the through-hole is formed in the housing portion. Such a configuration makes it possible to reduce the length of the main body, compared to the case where the airflow structural portion and the housing portion are shifted from each other in the length direction, and to more effectively adjust the internal pressure of the external member due to the airflow structural portion being arranged near the magnetic core.

Also, the grommet of the present disclosure may have a configuration in which the housing portion has contact surfaces that can come into contact with both end surfaces of the magnetic core in the axial direction, and the contact surfaces are provided with an airflow path that is in communication with an end of the main body in the axial direction. With such a configuration, even if the magnetic core comes into contact with a contact surface, the flow of air to the airflow structural portion is not prevented, and thus it is possible to prevent deterioration in the function of adjusting the internal pressure of the external member.

Also, the grommet of the present disclosure may have a configuration in which the through-hole is formed in a tubular protruding portion that protrudes outward from the housing portion, and a base portion of the tubular protruding portion on a circumferential surface of the housing portion is provided with an airflow path that is in communication with the tubular protruding portion. With such a configuration, even if the magnetic core comes into contact with the base portion of the tubular protruding portion on the circumferential surface of the housing portion, the flow of air to the airflow structural portion is not prevented, and thus it is possible to prevent deterioration in the function of adjusting the internal pressure of the external member.

### Embodiments

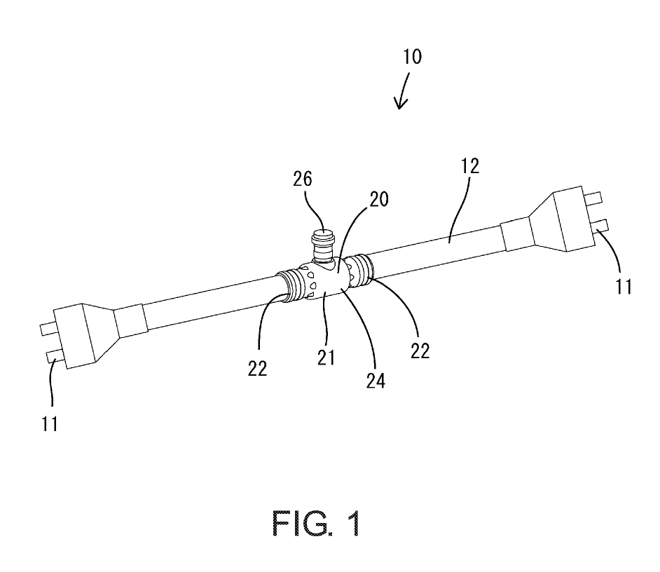

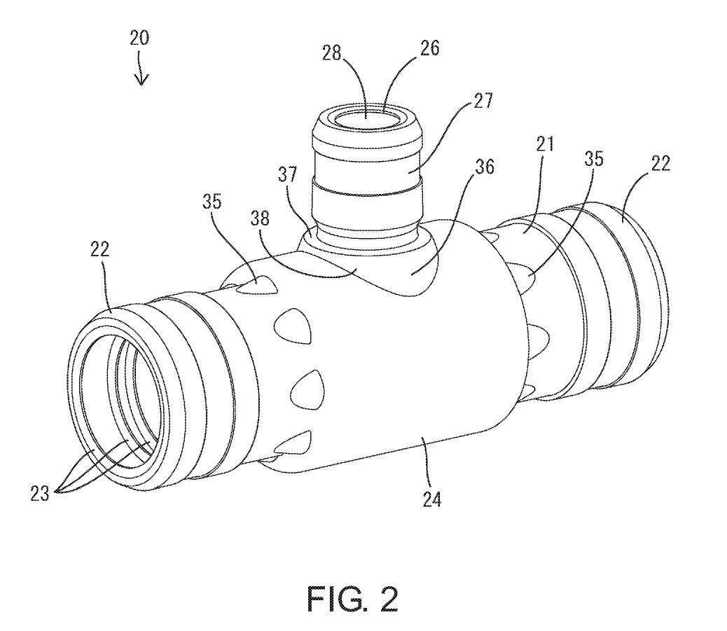

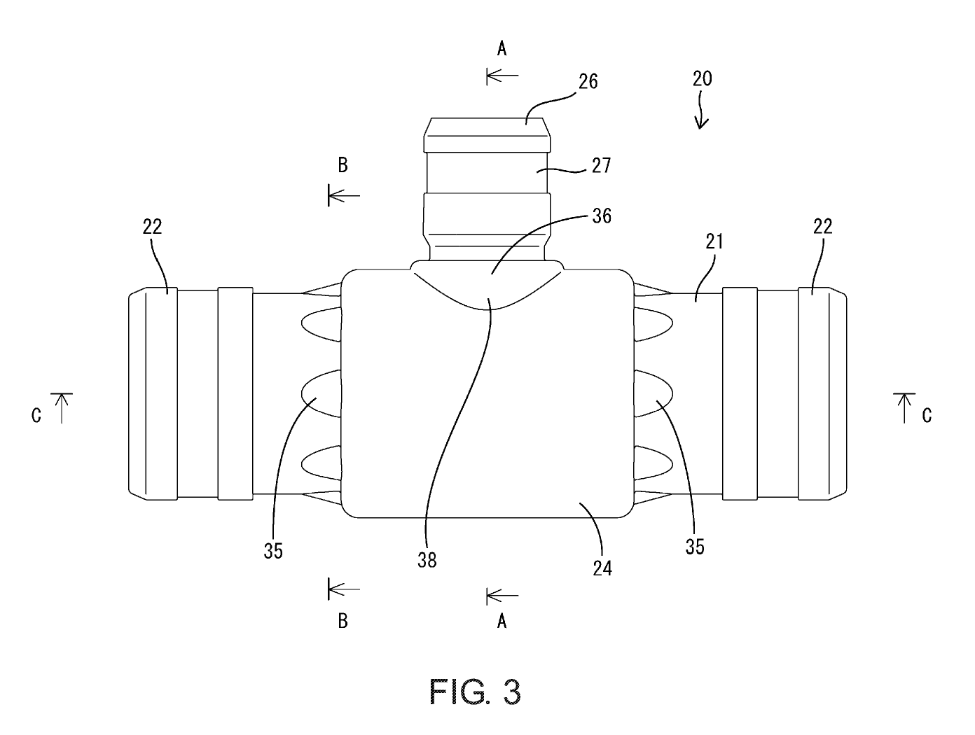

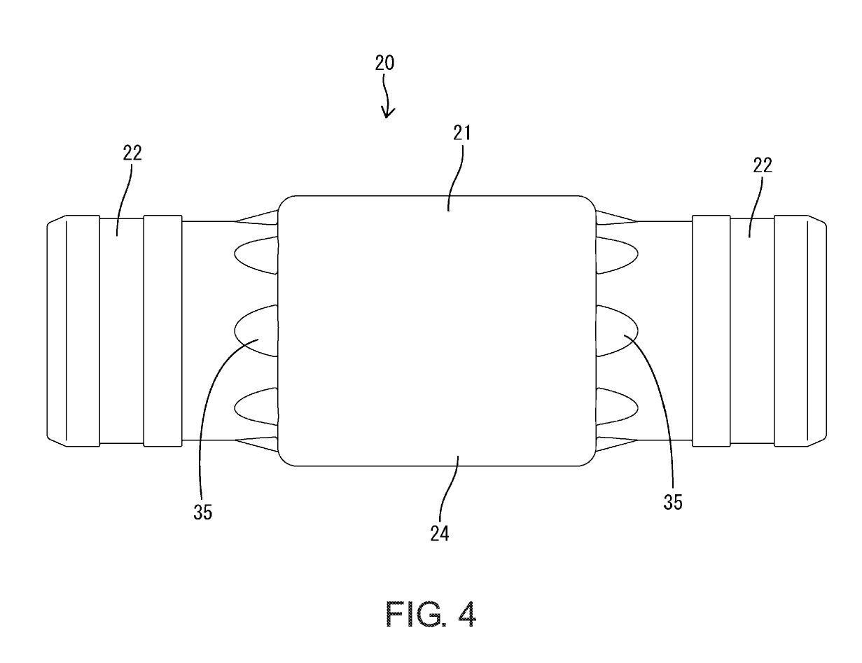

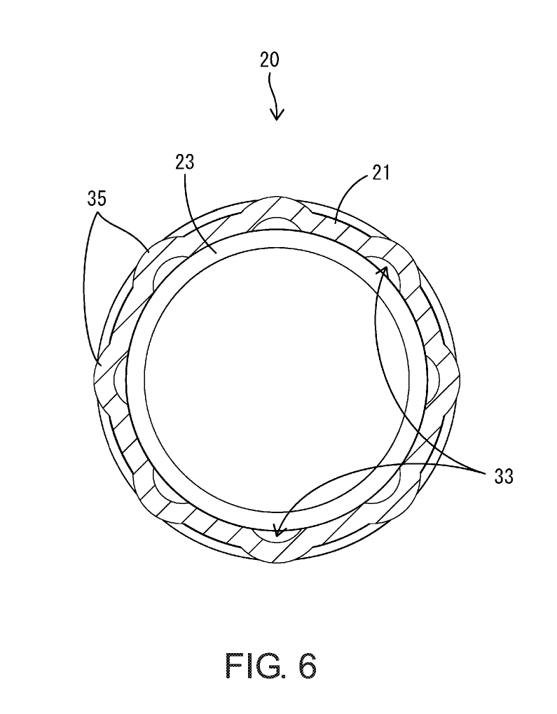

Hereinafter, an embodiment embodying the present disclosure will be described with reference to FIGS. 1 to 7.

A wire harness 10 in the present embodiment is a high-voltage wire harness that is attached to a hybrid car or the like, and most of the wire harness is routed underneath the floor of the vehicle. Connectors 11 are connected to both ends of the wire harness 10, the wire harness 10 is enveloped by the external member 12, and the inner portion of the external member 12 is completely sealed. The external member 12 includes a metal or resin pipe capable of collectively enveloping a plurality of electrical wires 13, a corrugated tube with no slit, a waterproof cover that can come into intimate contact with the connectors 11, or the like.

The wire harness 10 includes a grommet 20 that has a tubular shape capable of enveloping the wire harness 10 and is arranged at a middle portion of the wire harness 10 in the length direction, and a magnetic core 40 that is housed in a housing portion 24 of the grommet 20.

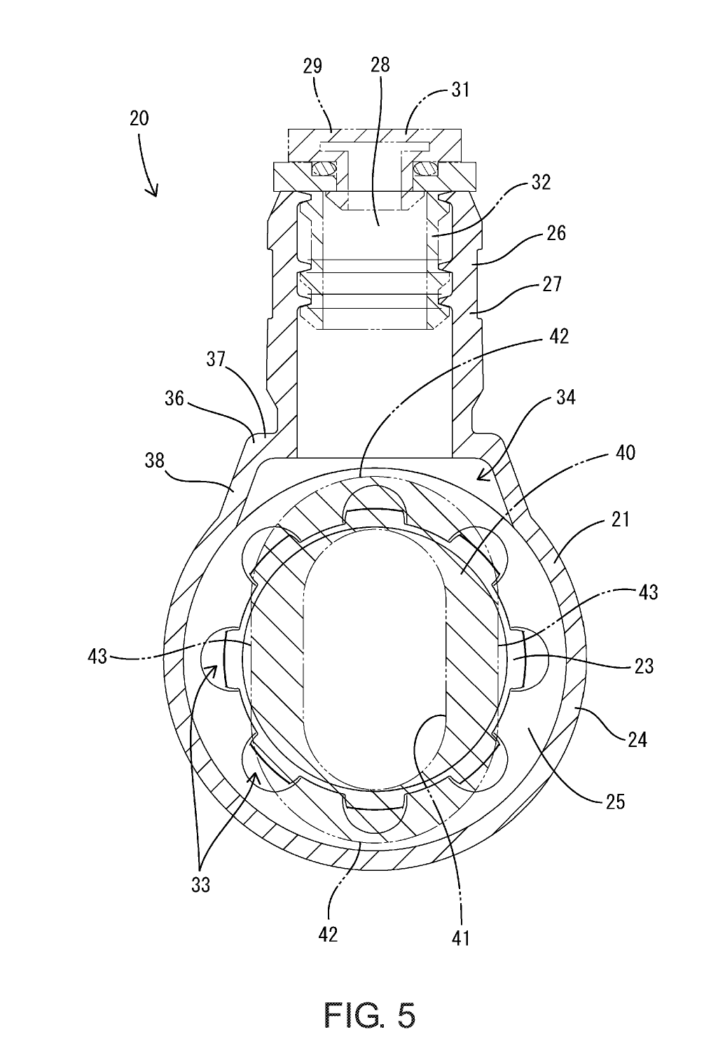

The magnetic core 40 has an annular shape with a hollow portion 41 through which the plurality of electrical wires 13 are collectively passed. As shown in FIG. 5, the magnetic core 40 has an oblong cross-section, and the outer circumferential surface includes first outer surfaces 42 located at both ends in the longitudinal direction of the cross-section and second outer surfaces 43 located at both ends in the lateral direction. The pair of first outer surfaces 42 are circular arc surfaces, and the pair of second outer surfaces 43 are approximately parallel to each other. The hollow portion 41 has an oblong shape, and the thickness of the magnetic core 40 is substantially constant over the entire circumference thereof.

The grommet 20 is made of an elastic material such as rubber, and has a main body 21 whose both ends are connected to an external member 12 in the axial direction. The main body 21 has a circular cross-section (circular tubular shape). The grommet 20 has a symmetrical shape with respect to the center in the axial direction (length direction), and the direction in which the grommet 20 is attached can be changed freely.

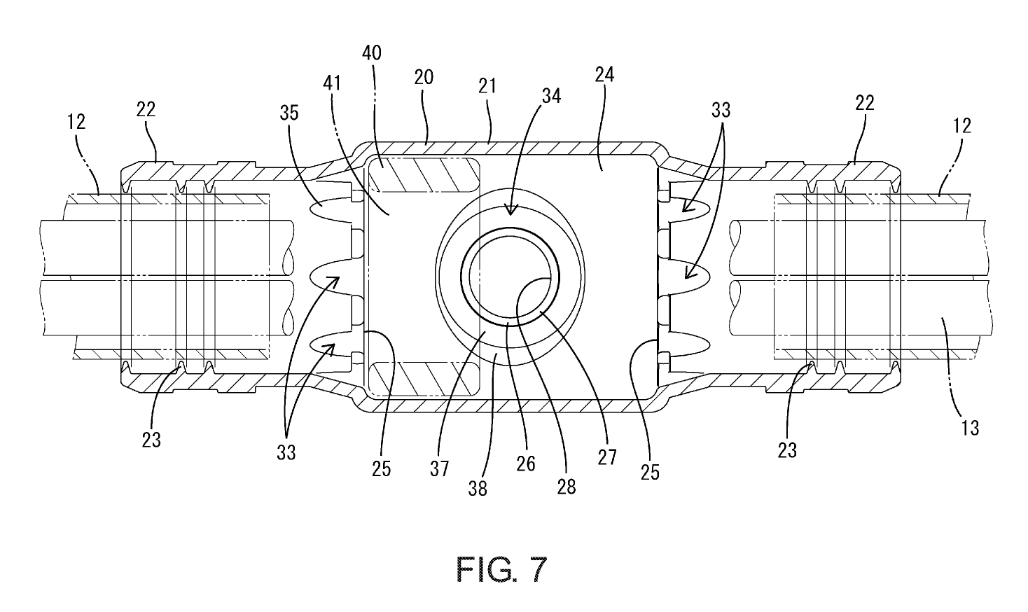

Both ends of the main body 21 in the axial direction (referred to as “connection portions 22” hereinafter) can be fitted around the end of each external member 12 (see FIG. 7). A plurality (three) of lip portions 23 protrude from the inner circumferential surface of the connection portions 22, and come into intimate contact with the outer circumferential surface of the external member 12.

The main body 21 is provided with the housing portion 24 capable of housing the magnetic core 40. The housing portion 24 is located at the center of the main body 21 in the axial direction. The housing portion 24 has a circular tubular shape that is slightly larger than the connection portions 22 in the vertical and horizontal directions, and the width of the internal space of the housing portion 24 is larger than that of the internal space of the connection portions 22. As shown in FIG. 5, the inner circumferential surface of the housing portion 24 has a circular arc shape extending along the first outer surfaces 42 of the magnetic core 40, and the magnetic core 40 can rotate at 360 degrees in the housing portion 24. Also, as shown in FIG. 7, the length of the housing portion 24 in the axial direction is larger than the length of the magnetic core 40 in the axial direction, and the magnetic core 40 is movable in the axial direction in the housing portion 24.

As shown in FIG. 7, the housing portion 24 has contact surfaces 25 that can come into contact with both end surfaces of the magnetic core 40 in the axial direction. The contact surfaces 25 are approximately orthogonal to the axial direction of the main body 21, and are formed at both ends of the housing portion 24 in the axial direction. As shown in FIG. 5, the contact surfaces 25 have an annular shape that is continuous over the entire circumference of the housing portion 24, and protrude inward past the inner circumferential surface of the connection portion 22. The magnetic core 40 is prevented from coming out of the housing portion 24 toward each of the connection portions 22 by coming into contact with the contact surfaces 25.

The main body 21 is provided with a through-hole 28 into which a waterproof member 29 with gas permeability can be fitted (see FIG. 5). The through-hole 28 is formed in a tubular protruding portion 27 protruding outward from the housing portion 24.

The tubular protruding portion 27 has a circular tubular shape, and protrudes from the center of the housing portion 24 in the axial and width directions. The tubular protruding portion 27 extends vertically from the housing portion 24, and the axis line of the tubular protruding portion 27 is orthogonal to the axis line of the housing portion 24.

The waterproof member 29 includes a gas-permeable membrane 31 made of a moisture-permeable waterproof material that has gas permeability and exhibits waterproof and dustproof functions, and an attachment part 32 that holds the gas-permeable membrane 31 and can be tightly fitted into the tubular protruding portion 27. The attachment part 32 has a circular tubular shape that can be fitted into the tubular protruding portion 27, and the gas-permeable membrane 31 is fixed to the end surface of the attachment part 32.

An airflow structural portion 26 including the tubular protruding portion 27 and the waterproof member 29 is capable of adjusting the internal pressure of the external member 12.

The grommet 20 is provided with first airflow paths 33 and a second airflow path 34 for ensuring sufficient airflow between the ends of the main body 21 (the connection portions 22) and the tubular protruding portion 27.

The first airflow paths 33 are airflow paths that bring the housing portion 24 and the connection portion 22 into communication, and as shown in FIG. 5, a plurality (8 in the present embodiment) of first airflow paths 33 are formed in the contact surface 25. The first airflow paths 33 are disposed in the contact surface 25 at equal intervals in the circumferential direction. One of the plurality of first airflow paths 33 of the contact surface 25 is arranged at a position that is the same as the position of the tubular protruding portion 27 in the circumferential direction of the contact surface 25. The first airflow paths 33 each have a semicircular shape that is open at the inner circumferential edge of the contact surface 25. The area of the first airflow paths 33 is largest on the contact surface 25, and the area of the first airflow paths 33 gradually decreases toward the end of the main body 21. The same number of first airflow paths 33 with the same shape are formed at the same positions on both contact surfaces 25 of the housing portion 24.

As shown in FIG. 5, the first airflow paths 33 are the internal spaces of protruding portions 35 formed at the ends of the housing portion 24. The width and height of each of the protruding portions 35 (the dimensions protruding from the main body 21) gradually decrease from the housing portion 24 toward the connection portion 22. All of the protruding portions 35 have the same shape.

As shown in FIG. 5, the second airflow path 34 is an airflow path that is in communication with the housing portion 24 and the tubular protruding portion 27, and is formed at the base portion of the tubular protruding portion 27 on the circumferential surface of the housing portion 24. The second airflow path 34 extends outward from the housing portion 24 in the radial direction, and extends outward from the tubular protruding portion 27 in the radial direction.

The second airflow path 34 is the internal space of a bulging portion 36 provided at the base portion of the tubular protruding portion 27 of the housing portion 24. The bulging portion 36 has a shape partially bulging outward from the housing portion 24, and includes a first wall 37 that is approximately orthogonal to the axis line of the tubular protruding portion 27, and a second wall 38 that is inclined and extends from the circumferential edge of the first wall 37 to the housing portion 24. As shown in FIG. 7, the first wall 37 has an annular shape protruding outward from the entire circumferential surface of the tubular protruding portion 27, and the second wall 38 extends downward from the entire circumferential surface of the first wall 37 at substantially the same gradient to the housing portion 24.

Even if the magnetic core 40 is arranged at any position in the housing portion 24 in any orientation, a sufficient airflow path (the space with an area that is larger than the area of the gas-permeable membrane 31) is secured between the magnetic core 40 and the grommet 20 due to the first airflow paths 33 and the second airflow path 34 being provided. That is, as shown in FIG. 7, even if the magnetic core 40 is arranged at an end of the housing portion 24 in the axial direction and the end surface of the magnetic core 40 in the axial direction abuts against the contact surface 25, a sufficient airflow path is secured by the first airflow paths 33 between the grommet 20 and the magnetic core 40. Also, as shown in FIG. 5, even if the magnetic core 40 is arranged directly below the airflow structural portion 26 (the central position of the housing portion 24 in the axial direction) and a first outer surface 42 is arranged orientated covering the base portion of the tubular protruding portion 27, a sufficient airflow path is secured by the second airflow path 34 between the grommet 20 and the magnetic core 40.

Next, an example of the work involved in assembling the wire harness 10 in the present embodiment will be described.

First, the magnetic core 40 is housed in the grommet 20. The magnetic core 40 is inserted into the grommet 20 from an end of the grommet 20. The connection portion 22 of the grommet 20 elastically opens, and the magnetic core 40 is housed in the housing portion 24. The magnetic core 40 housed in the housing portion 24 is arranged in an orientation such that the hollow portion 41 is open in the same direction as the axis line of the grommet 20 and the pair of first outer surfaces 42 extend along the inner circumferential surface of the housing portion 24.

Next, the external members 12 are connected. The end of an external member 12 is fitted into a connection portion 22 of the grommet 20, and the external member 12 is fixed by wrapping a fixing member (not shown) such as a cable tie around the external member 12. The connection portion 22 of the grommet 20 is in intimate contact with the end of the external member 12. By connecting the external members 12 to both ends of the grommet 20, different external members 12 can be connected thereto in a sealed state.

Next, the electrical wires 13 are passed through an external member 12. A terminal metal fitting (not shown) is connected to one of the ends of the electrical wires 13, and the end to which no terminal metal fitting is connected is passed through an external member 12. The plurality of electrical wires 13 that are bundled are passed through the external member 12 and the grommet 20 (the hollow portion 41 of the magnetic core 40), and the end of the electrical wires 13 are drawn out from an external member 12.

Next, the connectors 11 are connected to the ends of the electrical wires 13. A terminal metal fitting is connected to the end of the electrical wires 13 that has been drawn out from the external member 12, and the terminal metal fittings that are connected to both ends of the electrical wires 13 are respectively inserted into the connectors 11 in order.

Next, the end (waterproof cover) of each external member 12 is placed over the connector 11. Accordingly, the inner portion of the external member 12 is sealed.

As a result, the assembly of the wire harness 10 is complete.

Next, the effects of the embodiment having the above-described configuration will be described.

The grommet 20 of the present embodiment is a grommet that has a tubular shape capable of enveloping the wire harness 10 and is arranged at the middle portion of the wire harness 10 in the length direction, and the grommet 20 has the main body 21 whose both ends in the axial direction are each connected to another external member 12 configured to envelope the wire harness 10, and the main body 21 is provided with the housing portion 24 capable of housing the magnetic core 40. This configuration makes it possible to suppress an increase in the diameter of the wire harness 10, compared to the case where the magnetic core 40 is mounted on the outside of the external member 12. Also, the grommet 20 has a short length, and thus the magnetic core 40 can be easily inserted from an end of the grommet 20. That is, according to the grommet 20 of the present embodiment, it is possible to easily attach the magnetic core 40 to the wire harness 10 while suppressing an increase in the diameter of the wire harness 10.

Also, the main body 21 is provided with the through-hole 28 into which the waterproof member 29 that has gas permeability can be fitted. This configuration makes it possible to provide the grommet 20 for housing the magnetic core 40 that may act as a heat source with the airflow structural portion 26, and thus to effectively adjust the internal pressure of the external member 12.

Also, the through-hole 28 is formed in the housing portion 24. This configuration makes it possible to reduce the length of the main body 21, compared to the case where the airflow structural portion 26 and the housing portion 24 are shifted from each other in the length direction, and also makes it possible to effectively adjust the internal pressure of the external member 12 due to the airflow structural portion 26 being arranged near the magnetic core 40.

Also, the housing portion 24 has the contact surfaces 25 that can come into contact with both end surfaces of the magnetic core 40 in the axial direction, and the contact surfaces 25 are provided with the first airflow paths 33 that are in communication with the ends of the main body 21 in the axial direction. With this configuration, even if the magnetic core 40 comes into contact with a contact surface 25, the flow of air to the airflow structural portion 26 is not prevented, and thus it is possible to prevent deterioration in the function of adjusting the internal pressure of the external member 12.

Also, the through-hole 28 is formed in the tubular protruding portion 27 protruding outward from the housing portion 24, and the base portion of the tubular protruding portion 27 on the circumferential surface of the housing portion 24 is provided with the second airflow path 34 that is in communication with the tubular protruding portion 27. According to this configuration, even if the magnetic core 40 comes into contact with the base portion of the tubular protruding portion 27 of the circumferential surface of the housing portion 24, the flow of air to the airflow structural portion 26 is not prevented, and thus it is possible to prevent deterioration in the function of adjusting the internal pressure of the external member 12.

### OTHER EMBODIMENTS

The present disclosure is not limited to the embodiment described above using the foregoing description and drawings, and embodiments such as the following are also encompassed in the technical scope of the present disclosure.

(1) Although the grommet 20 includes the airflow structural portion 26 in the above-described embodiment, it is not absolutely necessary to provide the grommet with an airflow structural portion.

(2) A specific structure of the airflow structural portion 26 was described in the above-described embodiment, but the present disclosure is not limited thereto, and the structure of the airflow structural portion can be changed.

(3) The airflow structural portion 26 is provided in the housing portion 24 in the above-described embodiment, but the present disclosure is not limited thereto, and the airflow structural portion may be provided at a position that is shifted from the position of the housing portion in the axial direction.

(4) The through-hole 28 is formed in the tubular protruding portion 27 in the above-described embodiment, but the present disclosure is not limited thereto, and the through-hole may be formed in the main body without providing the main body with a protruding portion, for example.

(5) The housing portion 24 has the contact surfaces 25 that can come into contact with both end surfaces of the magnetic core 40 in the axial direction in the above-described embodiment, but the present disclosure is not limited thereto, and it is not absolutely necessary to provide the housing portion with a contact surface, and the magnetic core may be held by an elastic force of the housing portion in the direction in which the diameter of the housing portion decreases, for example.

(6) The shape, the number, the position, and the like of first airflow paths 33 are mentioned in the above-described embodiment, but the present disclosure is not limited thereto, and the shape and the like of the first airflow path can be changed.

(7) The shape and the like of the second airflow path 34 are mentioned in the above-described embodiment, but the present disclosure is not limited thereto, and the shape and the like of the second airflow path can be changed.

1. A grommet that has a tubular shape capable of enveloping a wire harness and is arranged at a middle in a length direction of the wire harness, the grommet comprising:
a main body whose one end in an axial direction is connected to an end of one external member configured to envelope the wire harness and another end is connected to an end of another external member that is different from the one external member; and
a housing that is provided in the main body and is capable of housing a magnetic core between the end of the one external member and the end of the other external member.

2. A grommet that has a tubular shape capable of enveloping a wire harness and is arranged at a middle in a length direction of the wire harness, the grommet comprising:
a main body whose both ends in an axial direction are each connected to another external member configured to envelope the wire harness; and
a housing that is provided in the main body and is capable of housing a magnetic core,
wherein the main body is provided with a through-hole into which a waterproof member with gas permeability can be fitted.

3. The grommet according to claim 2,
wherein the through-hole is formed in the housing.

4. The grommet according to claim 3,
wherein the housing has contact surfaces that can come into contact with both end surfaces of the magnetic core in the axial direction, and the contact surfaces are provided with an airflow path that is in communication with an end of the main body in the axial direction.

5. The grommet according to claim 3,
wherein the through-hole is formed in a tubular protrusion protruding outward from the housing, and
a base of the tubular protrusion on a circumferential surface of the housing is provided with an airflow path that is in communication with the tubular protrusion.

6. A wire harness comprising:
the grommet according to claim 1;
a magnetic core housed in the housing of the grommet; and
an external member configured to envelope the wire harness.
